(19) United States
(12) Patent Application Publication
(10) Pub. No.: US 2021/0071792 A1
(43) Pub. Date: Mar. 11, 2021

(54) CONNECTOR ASSEMBLY WITH OVERLAPPING HOSES

(71) Applicant: TI Group Automotive Systems, L.L.C., Auburn Hills, MI (US)

(72) Inventors: Charles Thrift, Farmington Hills, MI (US); Matt Stieber, Grosse Pointe Park, MI (US); Cletus J. Thielen, Shelby Township, MI (US); Christian Veraza, Auburn Hills, MI (US)

(21) Appl. No.: 17/008,850

(22) Filed: Sep. 1, 2020

(30) Foreign Application Priority Data
Sep. 9, 2019 (DE) 202019104968

(51) Int. Cl. F16L 33/20

(52) U.S. Cl. CPC F16L 33/20

(57) ABSTRACT

A connector assembly is provided comprising an adaptor, a first hose, a second hose and a fixing ring, wherein the adaptor comprises a first end section allocated to the first hose and a second end section allocated to the second hose, wherein a middle section of the adaptor is located between the first end section and the second end section, wherein the adaptor has a through bore for guiding a fluid. The first and second hoses surround the first and second end sections of the adaptor in a press-fit manner, wherein the second hose overlaps the first hose over at least a part of the middle section of the adaptor defining a hose overlap region. The inner overlapping surface sections of the first hose and the second hose are free of circumferential indentations in a relaxed condition of the first hose and the second hose.

### RELATED APPLICATIONS

This application claims priority to German Utility Model No. 20 2019 104 968, filed Sep. 9, 2019, the entire contents of which are incorporated herein by reference in their entirety.

### FIELD

The present disclosure relates to a connector assembly comprising an adaptor, a first hose, a second hose and a fixing ring. The second hose overlaps the first hose over at least a part of a middle section of the adaptor, wherein the fixing ring fixes the second hose on the first hose. The fixing ring is mounted onto the second hose, thereby exerting a clamping force onto the first hose and the second hose.

### BACKGROUND

Such a connector assembly is known from U.S. Pat. No. 7,503,589 B2 of the prior art. Here, two hoses, for example made from anyone or more of rubbers, fabrics and plastic materials, are connected by using an adaptor and a fixing ring. The first hose is mounted simply by press-fitting on the adaptor and by using a radial protrusion on a first end section of the adaptor. The second hose is surrounding the adaptor and the first hose in a press-fitting manner as well. The adaptor has a second end section comprising a radial protrusion thereby also enhancing the pressing force onto the second hose. A fixing ring in the form of a clamp ring is mounted onto the second hose thereby exerting a pressing force onto both hoses. Since the pressing force of the clamp ring is not high enough for the above mentioned hoses, U.S. Pat. No. 7,503,589 B2 teaches to use circumferential indentations on inner surfaces of the hoses. The indentations are complimentary with respect to the according protrusions of the adaptor thereby providing two engagements in the region of the first end section and the second end section. This increases the ability of the connector assembly to withstand pulling forces in axial direction.

However, we have discovered providing the indentations on inner surfaces of the hoses is a cost increasing manufacturing step.

### BRIEF SUMMARY

It is therefore the goal of the present disclosure to reduce manufacturing costs by avoiding said indentations and by nevertheless providing a sufficient ability of the connector assembly to withstand axial pulling forces. This goal is solved by using a connector assembly comprising an adaptor, a first hose, a second hose and a fixing ring, wherein the adaptor comprises a first end section allocated to the first hose and a second end section allocated to the second hose, wherein a middle section of the adaptor is located between the first end section and the second end section, wherein the adaptor has a through bore for guiding a fluid.

The first hose is surrounding the first end section of the adaptor in a press-fit manner, wherein the second hose is surrounding the second end section of the adaptor in a press-fit manner, wherein the second hose overlaps the first hose over at least a part of the middle section of the adaptor defining a hose overlap region, wherein the fixing ring fixes the second hose on the first hose, wherein the fixing ring is located such that it overlaps in axial direction at least a part of the hose overlap region,

An inner surface of the second hose contacts an outer surface of the first hose, wherein the outer surface of the first hose is formed by an outer contacting wall section of the first hose, wherein the inner surface of the second hose is formed by an inner contacting wall section of the second hose, wherein the first hose and the second hose each have an inner overlapping surface section overlapping the adaptor in axial direction,

The inner overlapping surface sections of the first hose and the second hose are free of circumferential indentations in a relaxed condition of the first hose and the second hose and that the inner contacting wall section of the second hose and/or the outer contacting wall section of the first hose is an elastomer.

The present disclosure is first based on the finding that indentations are laborious due to an additional manufacturing step which needs an according tool in order to provide a circumferential indentation or a groove on inner surfaces of the hoses. This is because hoses are produced via extrusion so that the cross section of an extruded hose is continuously the same along the length of the hose. The present disclosure is further based on the finding that the prior art (U.S. Pat. No. 7,503,589 B2) does not care about the polymer materials of the hoses so that its teaching concerning the indentations fits to every polymer hose combination. It is in particular a finding of this present disclosure that it is not necessary to respect the teaching of the prior art for certain hose combinations. This applies for connector assemblies where the inner contacting wall section of the second hose and/or the outer contacting wall section of the first hose comprises an elastomer. Here, the frictional connection between the first hose and the second hose is strong enough to compensate or even overcompensate the effect of indentations. The present disclosure thus solves the aforementioned goal.

It is possible that the first hose and/or the second hose is a multilayer hose. It is within the scope of the present disclosure that the first hose and/or the second hose only comprises one layer. The term “layer” preferably means a wall section comprising a homogenous material composition. The term “elastomer” preferably means a polymer material having a Young's modulus of lower than 500 MPa, more preferably of lower than 200 MPa, even more preferably of lower than 100 MPa and most preferably of lower than 50 MPa or even 20 MPa. It is possible that the second hose comprises only one homogenous polymer layer comprising an elastomer, wherein the only one homogenous polymer layer comprises the inner contacting wall section and the outer wall section of the second hose. Preferentially, the second hose comprises a reinforcement element, wherein the reinforcement element preferably comprises fibers which can be, for example, a knitted fabric comprising glass fibers or polymer fibers. It is preferred that the second hose is softer than the first hose or vice versa. Preferably, the Young's modulus of the second hose is at least factor 10 or 20 or 50 or 100 lower than the Young's modulus of the first hose or vice versa.

According to one embodiment, only the second hose comprises an elastomer. It is preferred that the inner contacting wall section of the second hose and/or the outer contacting wall section of the first hose covers at least parts of the hose overlap region and further preferentially the whole hose overlap region and most preferentially the whole inner surface of the second hose and/or the whole outer surface of the first hose.

An outer surface of the second hose may contact an inner surface of the fixing ring, wherein the outer surface of the second hose is formed by an outer wall section of the second hose, wherein the outer wall section of the second hose is an elastomer. It is preferred that the outer wall section of the second hose comprises the same material/the same elastomer as the inner contacting wall section of the second hose.

It is within the scope of the present disclosure that the wall of the second hose is at least 1.2, more preferably at least 1.5 and most preferably at least 1.8 times thicker than the wall of the first hose in a relaxed condition or vice versa. The outer diameter of the second hose in a relaxed condition is preferably at most 40 mm, more preferably at most 35 mm and very preferably at most 30 mm. The outer diameter of the second hose in a relaxed condition is according to a preferred embodiment at least 10 mm, more preferably at least 12 mm and very preferably at least 14 mm. According to an embodiment, the first hose has—in a relaxed condition—an outer diameter of at most 25 mm, preferably of at most 20 mm and very preferably of at most 17 mm. Preferably, the first hose has—in a relaxed condition—an outer diameter of at least 5 mm, preferably of at least 8 mm and very preferably of at least 10 mm.

It is possible that the fixing ring is a circumferential laser welding seam connecting the first hose to the second hose. According to a very preferred embodiment, the fixing ring is a separate member, wherein the fixing ring preferentially reduces the outer diameter of the second hose when the second hose is mounted on the first hose. It is preferred that the fixing ring is mounted on the second hose in a press-fit manner. The fixing ring is preferably mounted in a reversible or irreversible manner on the second hose. For example, the fixing ring is a clamp ring comprising a screw or a latch element in order to provide a reversible mounting of the fixing ring on the second hose. An irreversible mounting of the fixing ring can be provided, for example, with a fixing ring in the form of a crimped ring or a ring in a cable-tie manner. Preferably, the fixing ring exerts a clamping force of at least 1 N, more preferably of at least 2 N and very preferably of at least 5 N onto the second hose. The fixing ring preferably comprises a metal or a polymer.

Preferentially, the first end section and/or the second end section of the adaptor comprise/s a protrusion protruding radially outward compared to an outer surface of the middle section of the adaptor. It is preferred that the first end section is different from the second end section. According to a preferential embodiment, the second end section protrudes more radially outward compared to the first end section. It is very preferred that at least the second end section comprises a protrusion. The protrusion of the first end section and/or of the second end section preferably comprises a tapered section, wherein the tapered section is tapered in an axially outward direction for facilitating an engagement with the first hose and the second hose, respectively. It is preferred that the protrusion of the first end section and/or of the second end section comprises a shoulder axially facing toward the middle section of the adaptor.

According to another embodiment, a rotational axis of the first end section of the adaptor is identical to a rotational axis of the second end section of the adaptor. It is preferred that the first end section, the middle section and the second end section have the same rotational axis. According to another embodiment, the adaptor is purely rotationally symmetric. It is preferred that the adaptor comprises only two end sections.

It is within the scope of the present disclosure that the adaptor comprises a polymer and/or a metal. According to a preferred embodiment, the adaptor is a single-piece element preferably comprising a polymer. The polymer is preferably a polyamide and in particular a polyphthalamide. According to another embodiment, the polymer is a polyphenylene sulfide. The metal of the adaptor can be, for example, zinc, aluminum or stainless steel. It is possible that the adaptor is a composite element comprising a polymer and a metal.

The adaptor preferably has an axial length of at least 10 mm, more preferably of at least 15 mm further preferably of at least 20 mm and most preferably of at least 23 mm. The axial length of the adaptor is preferentially at most 60 mm, more preferably at most 50 mm, furthermore preferably at most 40 mm and most preferably at most 35 mm. The outer diameter of the middle section of the adaptor preferentially is at least 10 mm, preferentially at least 13 mm and most preferentially at least 15 mm or 17 mm. The outer diameter of the adaptor advantageously is at most 35 mm, furthermore advantageously at most 30 mm and most advantageously at most 25 mm. It is preferred that the shoulders of the first end section and the second end section define the middle section of the adaptor and in particular the axial length of the middle section in between them. Preferentially, the axial length of the middle section is at least 8 mm, more preferentially at least 10 mm, furthermore preferentially at least 12 mm and most preferentially at least 14 mm. The axial length of the middle section is preferably at most 40 mm, more preferably at most 35 mm, furthermore preferably at most 30 mm, even more preferably at most 25 mm and most preferably at most 20 mm.

The elastomer of the inner contacting wall section of the second hose and/or of the outer contacting wall section of the first hose and/or of the outer wall section of the second hose may be a thermoplastic elastomer or a rubber and preferably is EPDM. According to one form, only the second hose comprises an elastomer. It is possible that the first hose has at least two layers comprising an inner layer and an outer layer, wherein it is preferred that at least one of the two layers comprises a polyamide.

According to another embodiment, a stop element is disposed on the outer surface of the first hose. The stop element can be, for example, a radially protruding stop ring mounted onto the first hose or a marker ring or a marker dot marked onto the first hose. Preferably, the stop element comprises an axial inner end facing toward an end face of the second hose thereby defining an axial distance between each other. It is preferred that said axial distance is at most 10 mm, preferably at most 5 mm and very preferably at most 3 mm. Ideally, the end face of the second hose and the axial inner end of the stop element contact each other. It is very preferred that the stop element axially overlaps the first end section/the radial protrusion of the first end section. It is preferred that the axial length of the stop element is smaller than the axial length of a protruded section of the first hose induced by the first end section of the adaptor. It is very preferred that the stop element axially overlaps the shoulder of the first end section.

According to another embodiment, the stop element is a stop ring separate from the first hose, wherein it is preferred that the stop ring is secured—preferably in a press-fit manner—on the first hose. Preferably, the stop ring has an axial length of at least 2 mm, more preferably of at least 3 mm, even more preferably of at least 4 mm and most preferably of at least 5 mm. The axial length of the stop ring is advantageously at most 50 mm, more advantageously at most 40 mm, even more advantageously at most 30 mm/20 mm/15 mm/10 mm. It is very preferred that the stop ring is a single-piece element. Preferably, the stop ring comprises a polymer and very preferably a polyolefin or a polyamide.

According to another embodiment, the stop ring comprises an inner surface which is—with respect to a longitudinal section of the first hose—at least in sections complementary to the outer surface of the mounted first hose in the region of the first end section of the adaptor. Preferably, the inner surface of the stop ring comprises alternating circumferential sections. Preferably, each alternating circumferential section has a radially inwardly protruding part. It is preferred that at least some of the radially inwardly protruding parts comprise a tapered section. It is preferred that at least some of the tapered sections of the radially inwardly protruding parts are tapered in axially inwardly direction while other tapered sections of other radially inwardly protruding parts are tapered in axially outwardly direction. Here, the term “inwardly” means a tapering of the wall thickness of the stop ring in direction to the middle section of the adaptor. The term “outwardly” applies accordingly. In another embodiment, the axially inwardly and outwardly tapered sections are arranged in a circumferentially alternating manner. It is preferred that the alternating circumferential sections comprising the alternating tapered sections are composed in such a manner that they provide a stop ring with an inner surface which is at least in sections complementary to the outer surface of the first hose in the region of the first end section of the adaptor.

According to another embodiment, each alternating circumferential section has a non-protruding part with constant wall thickness.

### BRIEF DESCRIPTION OF THE DRAWINGS

The present disclosure shall be explained in greater detail below, based on the drawings depicting only one exemplary embodiment of the present disclosure. Therein, in schematic depictions:

FIG. 1 shows a longitudinal section of a connector assembly according to the present disclosure,

FIG. 2 shows the connector assembly of FIG. 1 during an intermediate mounting step and with an additional stop ring,

FIG. 3 shows a perspective view onto the stop ring of FIG. 2 and

FIG. 4 a side view of an adaptor of the connector assembly of FIG. 1 together with the stop ring of FIGS. 2 and 3, wherein the stop ring is depicted in a longitudinal section.

### DETAILED DESCRIPTION

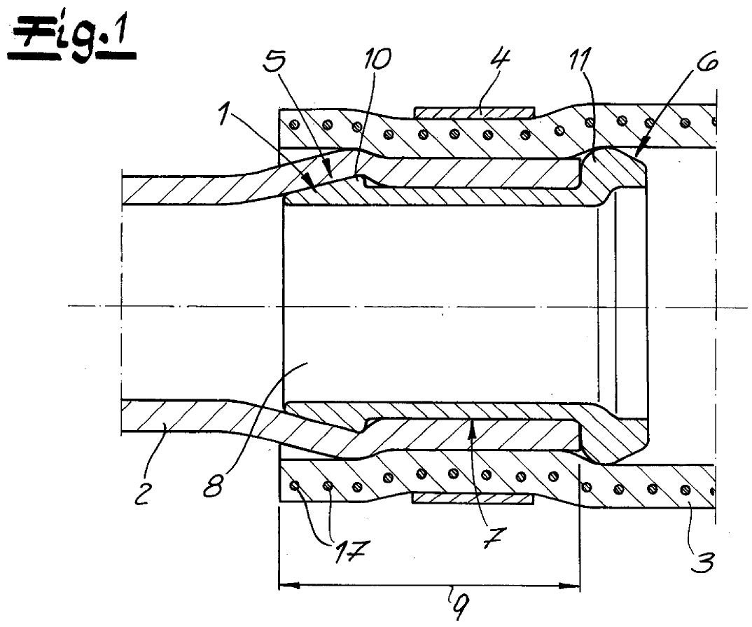

The above-mentioned FIG. 1 highlights the basic principle of a connector assembly according to the present disclosure. The connector assembly comprises an adaptor 1, a first hose 2, a second hose 3 and a fixing ring 4. The adaptor 1 of this embodiment is made of polyphthalamide and is a molded single-piece element. The first hose 2 of this embodiment is a multilayer tube and might in particular comprise at least one layer made of polyamide. The second hose 3 basically consists of EPDM and is thus an elastomer. The second hose 3 also has a reinforcing element 17 in the form of reinforcement fibers. The fixing ring 4 is a crimped ring and made of metal.

The adaptor 1 comprises a first end section 5, a second end section 6 and a middle section 7 which is disposed between the first end section 5 and the second end section 6. The first end section 5 comprises a protrusion 10 protruding radially outward. This protrusion 10 comprises a shoulder facing toward to the middle section 7 and a tapered section in order to facilitate an engagement of the first hose 2 on the adaptor 1. The second end section 6 comprises a radial protrusion 11 with a shoulder facing toward the middle section 7 and a tapered section for facilitating an engagement of the second hose 3 on the adaptor 1. It has to be noted that various different end sections 5, 6 can be combined together.

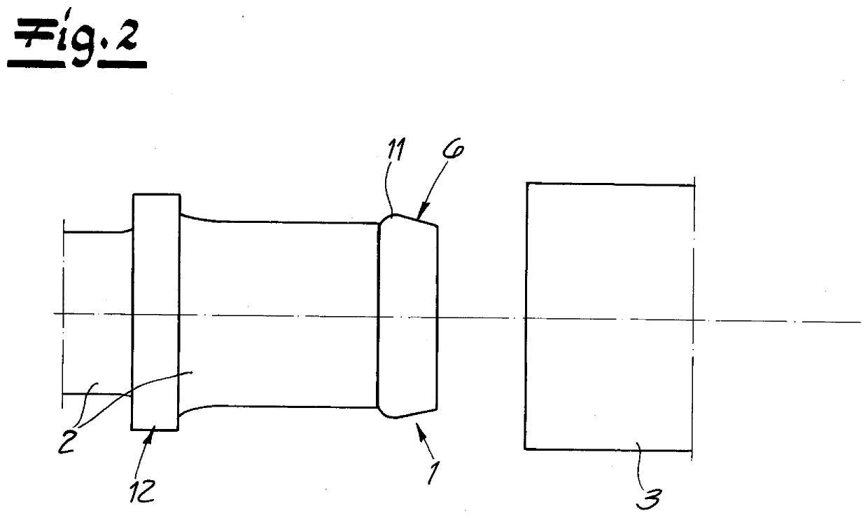

FIG. 2 highlights an intermediate manufacturing step, wherein the first hose 2 has already been mounted onto the adaptor 1. The first hose 2 of this embodiment completely covers the first end section 5 as well as the middle section 7 and abuts on the shoulder of the protrusion 11 of the second end section 6. Furthermore, a stop element 12 in the form of a stop ring has been pushed onto the first hose 2 in the region of the first end section 5. The next manufacturing step of this embodiment after FIG. 2 is to push the second hose 3 onto the adaptor 1 and over the first hose 2 until the face end of the second hose 3 abuts on the stop element 12. In a last step, the fixing ring 4 in the form of the crimped ring is mounted onto the second hose 3 in the region of the middle section 7.

As can be seen in FIG. 1, the fixing ring 4 exerts a pressing force onto the second hose 3 thereby reducing the outer diameter of the second hose 3. This pressing force in combination with said shoulders of the protrusions 10, 11 and furthermore in combination with the rubber-like material EPDM of the second hose 3 a reliable connection has been established between the first hose 2 and the second hose 3. In particular, the inner contacting wall section of the second hose 3 comprises EPDM and thus an elastomer thereby establishing a good frictional connection between the outer surface of the first hose 2 and the inner surface of the second hose 3.

The shoulder of the protrusion 11 provides a good manufacturing control possibility which also applies to the stop element 12. In both cases, an employee and/or a camera can easily control the correct mounting position of the first hose 2 and the second hose 3 on the adaptor 1 by controlling the distance between the face end of the first hose 2 and the shoulder of the protrusion 11 and the distance between the face end of the second hose 3 and the stop element 12, respectively. Both manufacturing control possibilities make a manufacturing process more reliable.

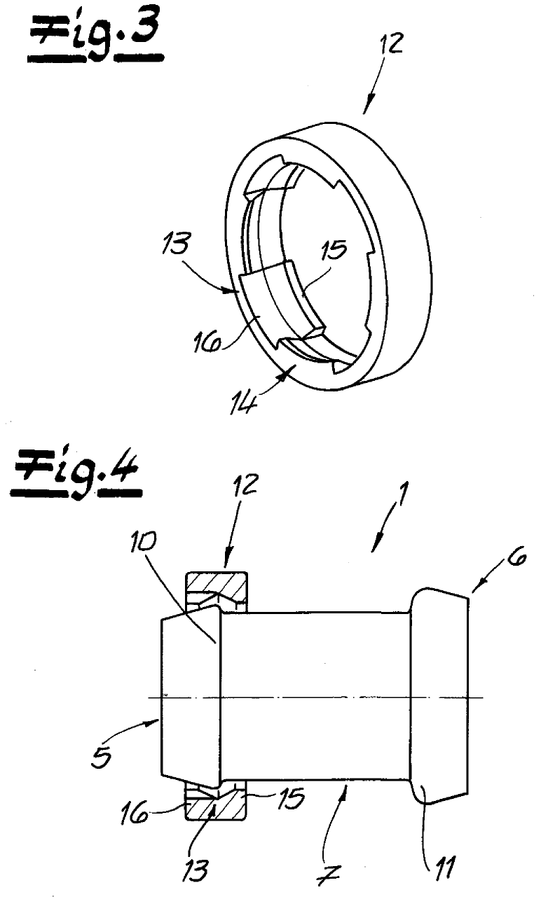

The stop element 12 is highlighted in FIG. 3 in a perspective view on the left and in a longitudinal section, mounted on the adaptor 1, in FIG. 4 on the right. As can be seen from the perspective view, the stop element 12 comprises a plurality of circumferentially alternating sections 13, 14 disposed on the inner surface of the stop element 12. In this embodiment, the stop element 12 comprises four sections 13 which are tapered in an axially outwardly direction and four sections 14 which are tapered in an axially inwardly direction. More precisely, each section 13, 14 comprises a protruding part 15 which protrudes radially inwardly. This protruding part 15 has a tapered inner surface ending in the axial middle of the stop element 12.

Each section 13, 14 also comprises a non-protruding part 16 with a constant thickness of the wall of the stop element 12. This can be seen in particular in the longitudinal section of the stop element 12 in FIG. 4. The alternating circumferential sections 13, 14 result in an inner surface of the stop element 12 which is complementary to the outer surface of the first hose 2 in the region of the first end section 5 which can also be seen in FIG. 4. It has to be noted that the first hose 2 is not shown in FIG. 3 which explains a certain distance between the outer surface of the first end section 5 and the inner surface of the stop element 12. The alternating arrangement of the sections 13, 14 facilitates pushing the stop element 12 onto the region of the first end section 5 while at the same time providing good fixation in the region of the first end section 5.

1. Connector assembly comprising an adaptor, a first hose, a second hose and a fixing ring, wherein the adaptor comprises a first end section allocated to the first hose and a second end section allocated to the second hose, wherein a middle section of the adaptor is located between the first end section and the second end section, wherein the adaptor has a through bore for guiding a fluid,
wherein the first hose is surrounding the first end section of the adaptor in a press-fit manner, wherein the second hose is surrounding the second end section of the adaptor in a press-fit manner, wherein the second hose overlaps the first hose over at least a part of the middle section of the adaptor defining a hose overlap region, wherein the fixing ring fixes the second hose on the first hose, wherein the fixing ring is located such that it overlaps in axial direction at least a part of the hose overlap region,
wherein an inner surface of the second hose contacts an outer surface of the first hose, wherein the outer surface of the first hose is formed by an outer contacting wall section of the first hose, wherein the inner surface of the second hose is formed by an inner contacting wall section of the second hose, wherein the first hose and the second hose each have an inner overlapping surface section overlapping the adaptor in axial direction, characterized in that the inner overlapping surface sections of the first hose and the second hose are free of circumferential indentations in a relaxed condition of the first hose and the second hose and that the material of the inner contacting wall section of the second hose and/or the material of the outer contacting wall section of the first hose is an elastomer.

2. The connector assembly according to claim 1, wherein an outdoor surface of the second hose contacts an inner surface of the fixing ring, wherein the outer surface of the second hose is formed by an outer wall section of the second hose, wherein the outer wall section of the second hose is an elastomer.

3. The connector assembly according to claim 1, wherein the wall of the second hose is at least 1.2 times thicker than the wall of the first hose.

4. The connector assembly according to claim 1, wherein the fixing ring is a separate member from the adaptor and first and second hoses, and wherein the fixing ring reduces the outer diameter of the second hose when the second hose is mounted on the first hose.

5. The connector assembly according to claim 1, wherein the first end section and/or the second end section of the adaptor comprise/s a protrusion protruding radially outward compared to an outer surface of the middle section of the adaptor.

6. The connector assembly according to claim 1, wherein a rotational axis of the first end section of the adaptor is identical to a rotational axis of the second end section of the adaptor.

7. The connector assembly according to claim 1, wherein the adaptor comprises a polymer and/or a metal.

8. The connector assembly according to claim 1, wherein a stop element is disposed on the outer surface of the first hose.

9. The connector assembly according to claim 8, wherein the stop element is a stop ring separate from the first hose, and wherein the stop ring is secured on the first hose.

10. The connector assembly according to claim 9, wherein the stop ring comprises an inner surface which is, with respect to a longitudinal section of the first hose, at least in sections complimentary to the outer surface of the mounted first hose in the region of the first end section of the adaptor.

11. The connector assembly according to claim 9, wherein the stop ring is secured in a press-fit manner on the first hose.

12. The connector assembly according to claim 1, wherein the wall of the second hose is at least 1.5 times thicker than the wall of the first hose.
